(19) United States
(12) Patent Application Publication
(10) Pub. No.: US 2004/0088440 A1
(43) Pub. Date: May 6, 2004

(54) Multi-format card read/write optical disc drive

(76) Inventors: Shimon Chen, Hsinchu (TW); Chanson Lin, Hsinchu (TW); Yu-Ting Chiu, Hsinchu (TW); Tsair Jinn Cheng, Hsinchu (TW); Joe Shyu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/347,207

(22) Filed: Jan. 21, 2003

(30) Foreign Application Priority Data
Nov. 1, 2002 (TW) 91217541

(51) Int. Cl. G06F 3/00

(52) U.S. Cl. 710/1

(57) ABSTRACT

A multi-format card read/write optical disc drive comprises a micro-controller for processing actions between each component. The micro-controller is connected to a read/write drive, a multi-format card read/write controller, a data codec (coder/decoder), an analog interface transducer, and a computer interface controller. Through the read/write drive and the multi-format card read/write controller, read/write actions are performed to an optical disc and memory cards of various formats, respectively. The data codec is used to decode compressed media data and encode raw data for compression. The analog interface transducer-receives a digital data decoded by the data codec and then converts them into an analog signal for output. The computer interface controller is used to provide connection with a computer for performing bi-directional communications with the computer. The multi-format read/write function of memory cards and optical discs can thus be accomplished, and the added value of the disc drive can also be enhanced.

### FIELD OF THE INVENTION

The present invention relates to an optical disc drive and, more particularly, to an optical disc drive, which has multi-format card read/write function, and can be connected with a computer.

### BACKGROUND OF THE INVENTION

Along with the progress of science and technology, the requirements to entertainment effects of modern people become higher and higher. Digital versatile discs (DVDs) capable of storing complex video and audio data and information data have become the present mainstream of optical discs. Devices used to read DVDs are generally called as DVD drives, and they are mainly used as electric appliances and computer peripherals. However, existent DVD drives commonly have only the function of playing optical discs and have no other added values. Computers are required for use if the data in the optical discs are to be backed up or stored to other places, resulting in much trouble of users.

On the other hand, along with continual development of the information industry, various kinds of electronic information products like mobile phones, notebook computers, personal digital assistants (PDAs), digital still cameras (DSCs) and so on provide different applications such as multimedia entertainments and data transmission via networks in everyday life. These portable electronic products usually require small memory cards for storage of various kinds of electronic data. Therefore, memory cards play a very important role. However, there are several different kinds of existent memory cards used by electronic products. These memory cards include compact flash (CF) memory cards, secured digital (SD) memory cards, PCMCIA memory cards and smart media (SM) memory cards. One electronic device cannot directly perform read/write and transmission of data of memory cards of different specifications. It is necessary to make use of the connection of a card reader or a computer, resulting in inconvenient use.

Accordingly, the present invention aims to propose a DVD drive having multi-format card read/write function and a computer connection interface so as to simultaneously solve the above problems in the prior art.

### SUMMARY OF THE INVENTION

The primary object of the present invention is to provide a multi-format card read/write optical disc drive, wherein a multi-format card read/write controller is used to let a DVD drive be capable of directly reading memory cards of several kinds of specifications so that video and audio data stored in the memory cards can be directly played or video and audio data being played can be stored into each memory card.

Another object of the present invention is to let a multi-format card read/write optical disc drive become a card reader having the function of computer after it is connected to a computer via a computer interface controller thereof, thereby performing bi-directional communication of data and command statuses.

Another object of the present invention is to enable mutual copying of data of each memory card or optical disc through a multi-format card read/write optical disc drive.

Another object of the present invention is to provide a multi-format card read/write optical disc drive having a high added value.

According to the present invention, a multi-format card read/write optical disc drive comprises a micro-controller for actions between each component. The micro-controller is connected to a read/write drive, a multi-format card read/write controller, a media data codec (coder/decoder), an analog interface transducer, and at least a computer interface controller. After the read/write drive accepts a read/write command to an optical disc from the micro-controller, it performs a read/write action to the optical disc. The multi-format card read/write controller is used to accept read/write commands to each memory card of a certain specification from the micro-controller so as to perform read/write actions to the memory card. The media data codec is used to decode compressed data and encode raw data for compression. The analog interface transducer is used to convert a digital data decoded by the media data codec into an analog signal for output. The computer interface controller is used to provide connection with a computer for performing bi-directional communications with the computer.

The various objects and advantages of the present invention will be more readily understood from the following detailed description when read in conjunction with the appended drawing, in which:

### BRIEF DESCRIPTION OF THE DRAWINGS

FIG. 1 is a structural block diagram of the present invention;

FIG. 2 is an action flowchart of the present invention for reading a DVD;

FIG. 3 is an action flowchart of the present invention for writing data into a DVD;

FIG. 4 is an action flowchart of the present invention for reading data of a memory card;

FIG. 5 is an action flowchart of the present invention for writing data into a memory card;

FIG. 6 is an action flowchart of the present invention for performing mutual data transmission of two memory devices;

FIG. 7 is an action flowchart of the present invention for performing data read/write by using a computer; and

FIG. 8 is an action flowchart of the present invention for processing a remote control command.

### DETAILED DESCRIPTION OF THE PREFERRED EMBODIMENTS

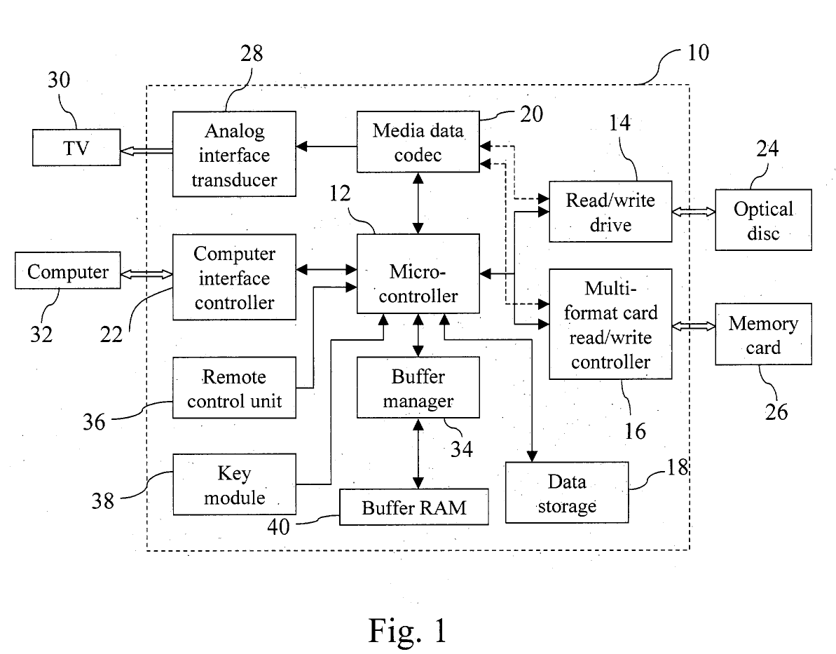

As shown in FIG. 1, a multi-format card read/write optical disc drive 10 comprises a micro-controller 12 for controlling and processing actions and signal communications between each component. The micro-controller 12 is connected to a read/write drive 14, a multi-format card read/write controller 16, a data storage 18, a media data codec 20, and a computer interface controller 22. The read/write drive 14 is used to accept a disc read/write command issued by the micro-controller 12 and perform read/write of data to an optical disc 24 according to the disc read/write command. The read/write drive 14 can perform read/write of the optical disc 24 of the format like DVD, DVD+R/RW, DVDR/RW, VCD, SVCD, CD-R, CD, or MP3. The multi-format card read/write controller 16 is used to accept a read/write command to memory cards of various kinds of specifications from the micro-controller 12 so as to perform data read/write to a memory card 26. The specifications of the memory card 26 include secured digital (SD), multimedia card (MMC), smart media (SM), memory stick (MS), compact flash (CF) and XD-picture formats. The data storage 18 is a storage having a large capacity, generally being a hard disk drive, and is used to store data on the optical disc 24 and the memory card 26 or data inputted from a computer end.

The media data codec 20 is used to decode compressed media data (i.e., decompression) and encode raw data for compression. For instance, the media data codec 20 decompresses media data of MPEG1, MPEG2 or JPEG format, or compresses raw data into media data of the above format. The media data codec 20 is connected to an analog interface transducer 28, which is used to receive digital data decoded by the media data codec 20 and convert them into analog signals of format receivable by television like AV signals, PAL signals, S-Video signals or NTSC signals so that the media digital data can be played using a television 30. The computer interface controller 22 provides a connection with a computer 32 to provide bi-directional communications including data transmission, command reception and status report between the multi-format card read/write optical disc drive 10 and the computer 32. The computer interface provided by the computer interface controller 22 is generally of a standard interface format like USB, IEEE 1394 and serial ATA.

There are also a buffer manager 34, a remote control unit 36 and a key module 38 connected to the micro-controller 12. Through the management of the buffer manager 34 and a buffer RAM 40 connected therewith, the speed and stability of data transmission are enhanced. The remote control unit 36 is used to accept a command from a far end remote controller and then process and respond to it. The key module 36 makes use of several keys to provide simple function settings.

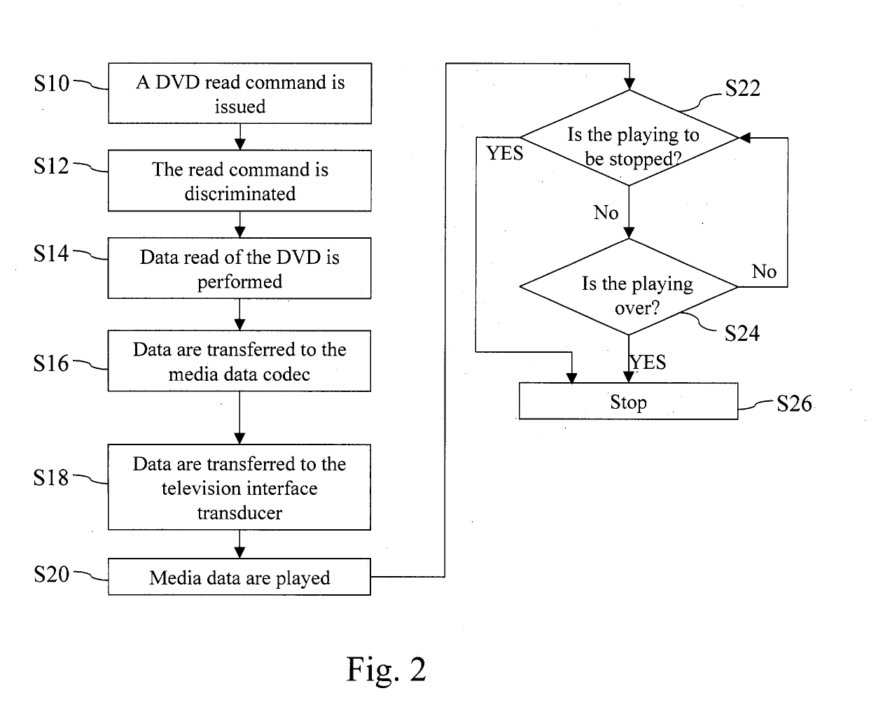

The multi-format card read/write optical disc drive 10 has the functions of optical disc read/write, memory card read/write, data communications between various kinds of memory devices, and data read/write of the computer end. The present invention will be exemplified below with a DVD drive. FIG. 2 is a flowchart of the present invention for reading a DVD. A user sends out a DVD read command through the key module 38, a remote control end or the computer 32 (Step S10). Next, the remote control unit 36 or the micro-controller 12 discriminates this read command, and the micro-controller 12 delivers a driving command to the read/write drive 14 if this read command is confirmed (Step S12). The read/write drive 14 then starts to read data in the DVD 24 (Step S14). Subsequently, the read/write drive 14 transfers read media data to the media data codec 20 for decompression (Step S16). Next, the decompressed data are transferred to the analog interface transducer 28, which converts the received digital data-into analog media signals receivable by the television 30 (Step S18). The television 30 then plays the analog media signals (Step S20). During the playing process, the remote control unit 36 and the micro-controller 12 will determine whether a command for stopping playing is received (Step S22). If the answer is negative, Step S24 is jumped to; otherwise, the flowchart is directly ended (Step S26). In Step S24, the micro-controller 12 will determine whether the playing is over. If the answer is positive, Step S26 is jumped to for ending the flowchart; otherwise, Step S22 is jumped to for repeating the actions of Steps S22 to S24.

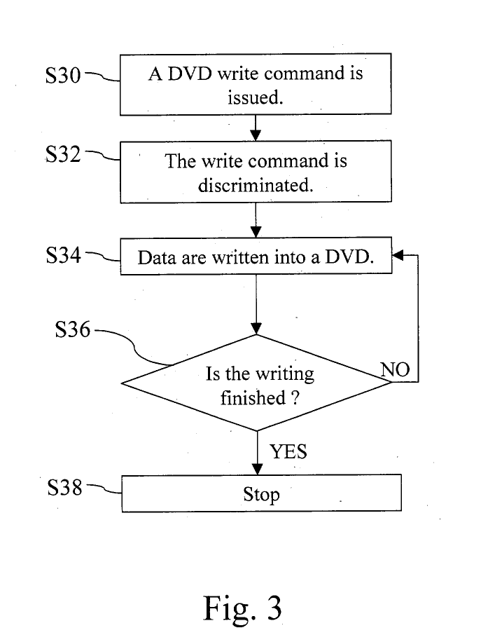

FIG. 3 is a flowchart of the present invention for writing data into a DVD. First, the remote control end or the computer end sends out a DVD write command (Step S30). Next, the remote control unit 36 or the micro-controller 12 discriminates this write command, and Step S34 is jumped to if this write command is confirmed (Step S32). In Step S34, the read/write drive 14 writes data into the DVD 24. Subsequently, the micro-controller 12 determines whether the writing is finished (Step S36). If the answer is negative, Step S34 is repeated; otherwise, the flowchart is ended (Step S38).

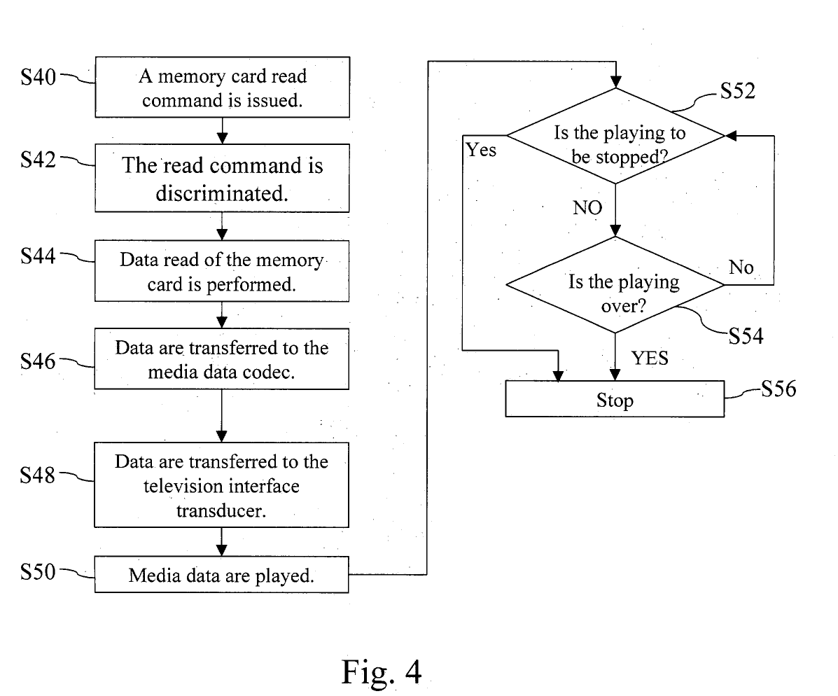

FIG. 4 is a flowchart of the present invention for reading a memory card. First, a user sends out a memory card read command through the key module 38, the remote control end or the computer 32 (Step S40). Next, the remote control unit 36 or the micro-controller 12 discriminates this read command, and Step S44 is jumped to if this read command is confirmed (Step S42). In Step S44, the multi-format card read/write controller 16 starts to read data in the memory card 26. Subsequently, the multi-format card read/write drive controller 16 transfers read media data to the media data codec 20 for decoding (Step S46). Next, the decoded data are transferred to the analog interface transducer 28, which converts the received digital data into analog signals (Step S48). The television 30 receives the analog signals and then plays the media data (Step S50). During the playing process, the micro-controller 12 will determine whether a command for stopping playing is received (Step S52). If the answer is positive, Step 56 is jumped to for ending the flowchart; otherwise, Step S54 is jumped to. In Step S54, the micro-controller 12 will determine whether the playing is over. If the answer is negative, Step S52 is repeated; otherwise, Step 56 is jumped to for ending the flowchart.

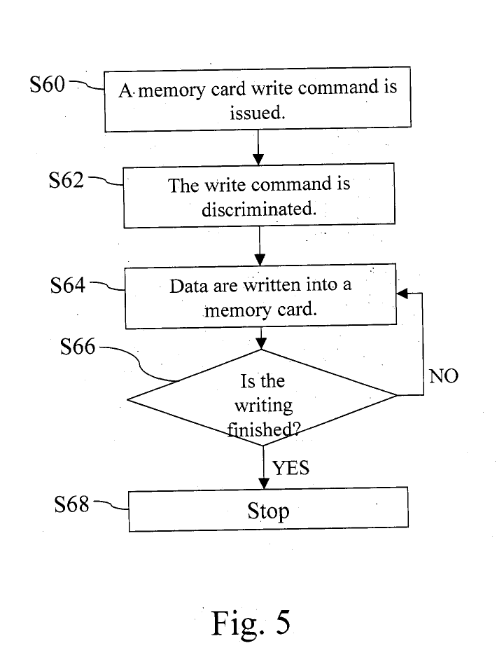

FIG. 5 is a flowchart of the present invention for writing data into a memory card. First, a memory card write command is issued (Step S60). The data to be written can be from the computer 32, the optical disc 24 or the data storage 18. During the playing of the optical disc 24, this write command can also be issued to record the desired media frames. Next, after the micro-controller 12 confirms this write command, it sends out a write-in signal to the multi-format card read/write controller 16 (Step S62). The multi-format card read/write controller 16 then writes data to be written into the memory card 26 according to the write-in signal (Step S64). Subsequently, the micro-controller 12 determines whether the writing is finished (Step S66). If the answer is negative, Step S64 is repeated; otherwise, the flowchart is ended (Step S68).

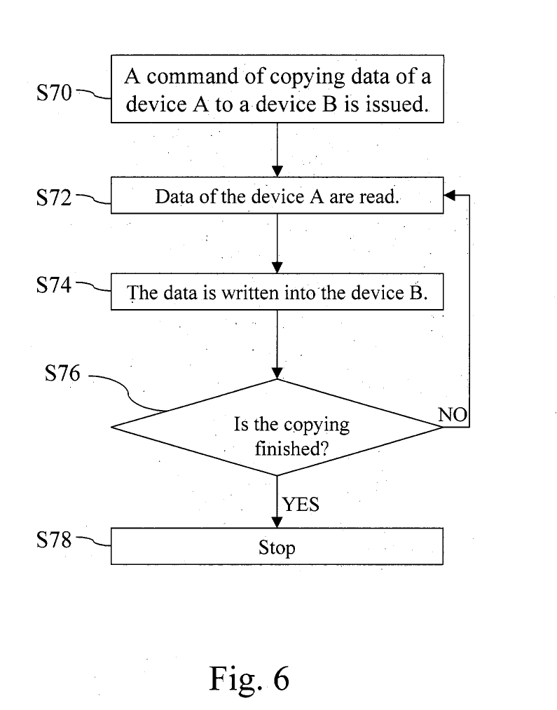

FIG. 6 is a flowchart of the present invention for performing mutual data transmission between various kinds of memory devices including the memory card 26, the optical disc 24, the data storage 18 and the computer 32. A device A and a device B will represent two memory devices performing mutual data transmission below. First, a command for copying data of the device A to the device B is issued (Step S70). Next, data of the device A are read after this command is accepted (Step S72). The read data are then written into the device B (Step S74). Subsequently, whether the copying is finished is determined (Step S74). If the answer is negative, Step S72 is repeated to continually read data of the device A; otherwise, the flowchart is ended (Step S78).

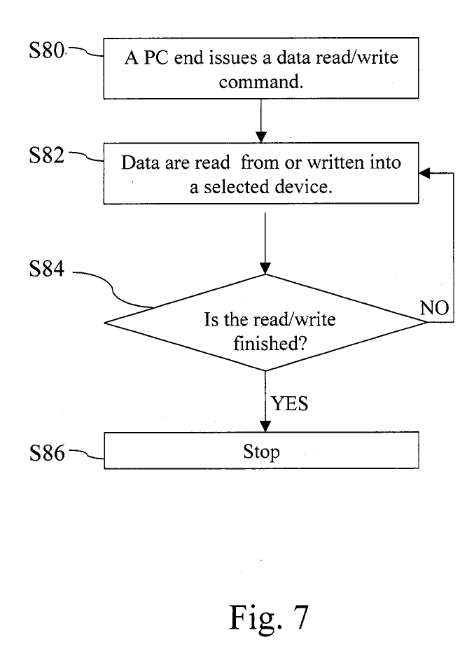

FIG. 7 is a flowchart of the present invention for performing data read/write by using the computer 32. First, the computer 32 issues a data read/write command (Step S80). Next, after the micro-controller 12 accepts this command via the computer interface controller 22, it will read data from or write data into a selected device (Step S82). The selected device can be the optical disc 24, the memory card 26 or the data storage 18. The micro-controller 12 then determines whether the read/write is finished (Step S84). If the answer is negative, Step S82 is repeated; otherwise, Step 86 is jumped to for ending the flowchart.

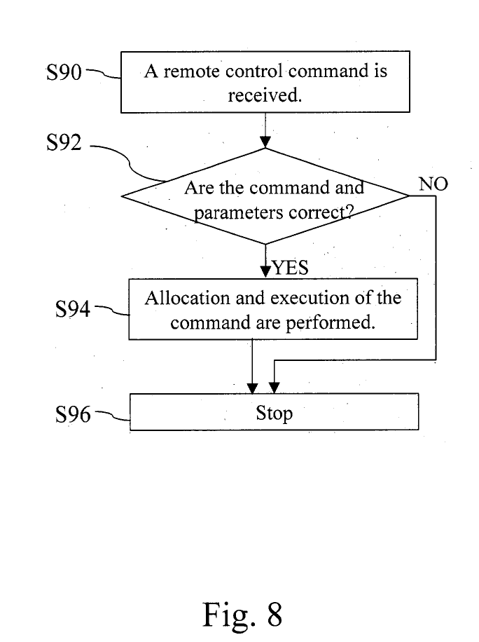

FIG. 8 is a flowchart of the present invention for processing a remote control command. First, after the remote control unit 6 receives a remote control command from the far end remote controller, whether the command and parameters are correct is determined (Step S92). If the answer is negative, Step S96 is jumped to for ending the flowchart; otherwise, Step S94 is jumped to. In Step S94, the micro-controller 12 performs allocation of the command and drives a device accepting this command to execute this command. Finally, Step S96 is jumped to for ending the flowchart.

To sum up, the present invention makes use of a multi-format card read/write controller to let a DVD drive be capable of directly reading memory cards of several kinds of specifications so that media data stored in the memory cards can be directly played or the media data being played can be stored into each memory card. Therefore, a more convenient and friendly optical disc drive can be provided. Moreover, the multi-format card read/write optical disc drive becomes a card reader having the function of a computer after it is connected to a computer via a computer interface controller thereof, thereby performing bi-directional communications of data and command statuses. Furthermore, mutual copying of data of each memory card or optical disc through the multi-format card read/write optical disc drive can be accomplished. Therefore, the present invention can greatly enhanced the added value of an optical disc drive.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A multi-format card read/write optical disc drive comprising:
a micro-controller used to control and process actions between each component;
a read/write drive connected to said micro-controller and used to accept a read/write command to an optical disc from said micro-controller for performing a read/write action to said optical disc;
a multi-format card read/write controller connected to said micro-controller and used to accept a read/write command to a memory cards of a certain format from said micro-controller for performing a read/write action to said memory card;
a media data codec connected to said micro-controller and used to decode compressed data and encode raw data for compression;
an analog interface transducer for receiving a digital data decoded by said media data codec and converting it into an analog signal for output; and
at least a computer interface controller connected to said micro-controller, said computer interface controller providing a connection with a computer for bi-directional communications with said computer.

2. The multi-format card read/write optical disc drive as claimed in claim 1 further comprising a data storage.

3. The multi-format card read/write optical disc drive as claimed in claim 2, wherein said data storage is a hard disk drive.

4. The multi-format card read/write optical disc drive as claimed in claim 1, wherein a buffer manager connected with a buffer RAM is further connected to said micro-controller.

5. The multi-format card read/write optical disc drive as claimed in claim 1 further comprising a remote control unit.

6. The multi-format card read/write optical disc drive as claimed in claim 1, wherein the format of said optical disc read/written by said read/write drive is selected among the group composed of DVD, DVD+R/RW, DVD-R/RW, VCD, SVCD, CD-R, CD and MP3.

7. The multi-format card read/write optical disc drive as claimed in claim 1, wherein the type of said memory card is selected among the group composed of SD, MMC, SM, MS, CF and XD-picture.

8. The multi-format card read/write optical disc drive as claimed in claim 1, wherein the format of said analog signal is selected among the group composed of AV, PAL, S-Video and NTSC.

9. The multi-format card read/write optical disc drive as claimed in claim 1, wherein the format of an interface provided by said computer interface controller is selected among the group composed of USB, IEEE 1394 and serial ATA.

10. The multi-format card read/write optical disc drive as claimed in claim 1 further comprising a key module.
